(19) United States
(12) Patent Application Publication
(10) Pub. No.: US 2014/0202008 A1
(43) Pub. Date: Jul. 24, 2014

(54) Modified Axe

(71) Applicant: Glenn Scott Preston, Salem, MA (US)

(72) Inventor: Glenn Scott Preston, Salem, MA (US)

(21) Appl. No.: 13/744,435

(22) Filed: Jan. 18, 2013

(51) Int. Cl. B26B 23/00

(52) U.S. Cl. CPC B26B 23/00
USPC 30/299

(57) ABSTRACT

A modified axe head with a front-end containing a double-beveled axe blade and a back end containing a straight flat blade with a beveled blade edge. The back end blade contains a flexible hinge that allows the blade to pivot upwards and downwards as a result of applied force. The back end blade can be quickly inserted by firefighters in between doors, wall holes, floorboards, or roofing tiles for more gently opening or removing of these obstacles in an old or unstable buildings during search and rescue operations.

### FIELD OF THE INVENTION

This invention relates to an improved axe combined with a adze with a beveled edge.

### BACKGROUND OF INVENTION

Axes are powerful tools used by firefighters during search and rescue operations inside burning buildings. Axes allow firefighters to forcible enter closed portions of the building by breaking down locked or blocked doors, breaking through walls or fallen debris, and breaking through floors or ceilings. Furthermore, firefighters often feel their way through smoke-filled buildings by sweeping the areas around them with an axe. This sweep may allow a firefighter to discover obstacles or victims in low to zero visibility environments.

Axes do have limitations in search and rescue operations. The blade of the axe may be too large to be quickly and safely inserted into smaller openings in closed doors, roofing tiles, or smaller wall holes. It some situations, where a burning structure is old or unstable, it may be beneficial to pry open a closed door, make a wall hole wider, or remove roofing tiles without the application of the blunt force of the axe blade. Furthermore, an axe blade is limited in removing soil when preparing firebreaks in forest fires.

Axes may also be quite useful in the structural deconstruction of the selective dismantling of building structures for remodeling. This may include the harvesting and recycling of older materials from the structure. Deconstruction requires the quick removal of windows, doors, and roofing tiles from an older structure. However, axes may not be the best tool for removing doors, windows, or tiles that can be harvested due to the blunt force of the applied axe blade.

Since firefighters are constructions workers work more efficiently and quickly with a smaller number of tools, an improved axe tool is needed that can accomplish the various tasks that may be encountered in a burning building or a deconstruction project. This efficiency is extremely important as firefighters have limited time to save victims before they succumb to fire, and deconstruction workers have limited funds and time to clear out or harvest old materials from a building being reconstruction begins.

The invention of this application, an improved axe, can quickly and efficiently accomplish these goals while still retaining the beneficial properties of a standard axe.

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The subject invention discloses an improved axe comprising: an axe head comprising a front end and a back end, wherein the front end comprises two inclined substantially flat planes ending distally with a double-beveled first blade edge, further wherein the double-beveled first blade edge further comprises a toe on a top portion and a heel on a bottom portion, wherein the front end further comprises an opening for receiving an elongated handle configured to held by at least one hand, wherein the handle comprises a bottom end and top end, wherein the top end is received within an opening on the axe head, wherein the double-beveled first blade edge is substantially parallel with the elongated handle, wherein the back end of the axe head comprises a single inclined substantially flat blade ending distally with a beveled second blade edge, wherein the single inclined flat plane of the back end is substantially perpendicular with the two inclined flat planes of the front end, wherein the single inclined flat blade of the back end comprises a substantially flat top surface, a substantially flat bottom surface, and substantially flat side surfaces, and further wherein a proximal end of the single inclined substantially flat blade comprises a flexible hinge that allows the blade to pivot upwards and downwards as a result of applied force.

Another embodiment of the subject invention is an improved axe comprising: an axe head comprising a front end and a back end, wherein the front end comprises two inclined substantially flat planes ending distally with a first blade edge, further wherein the first blade edge further comprises a toe on a top portion and a heel on a bottom portion, wherein the front end further comprises an opening for receiving an elongated handle configured to held by at least one hand, wherein the handle comprises a bottom end and top end, wherein the top end is received within an opening on the axe head, wherein the first blade edge is substantially parallel with the elongated handle, wherein the back end of the axe head comprises a single inclined substantially flat blade ending distally with a beveled second blade edge, wherein the single inclined flat plane of the back end is substantially perpendicular with the two inclined flat planes of the front end, wherein the single inclined flat blade of the back end comprises a substantially flat top surface, a substantially flat bottom surface, and substantially flat side surfaces, and further wherein a proximal end of the single inclined substantially flat blade comprises a flexible hinge that allows the blade to pivot upwards and downwards as a result of applied force.

A further embodiment of the subject invention is an improved axe comprising: an axe head comprising a front end and a back end, wherein the front end comprises two inclined substantially flat planes ending distally with a double-beveled first blade edge, wherein the front end further comprises an opening for receiving an elongated handle configured to held by at least one hand, wherein the handle comprises a bottom end and top end, wherein the top end is received within an opening on the axe head, wherein the double-beveled first blade edge is substantially parallel with the elongated handle, wherein the back end of the axe head comprises a single inclined substantially flat blade ending distally with a beveled second blade edge, wherein the single inclined flat plane of the back end is substantially perpendicular with the two inclined flat planes of the front end, wherein the single inclined flat blade of the back end comprises a substantially flat top surface, a substantially flat bottom surface, and substantially flat side surfaces, and further wherein a proximal end of the single inclined substantially flat blade comprises a flexible hinge that allows the blade to pivot upwards and downwards as a result of applied force.

An additional embodiment of the subject invention is an improved axe comprising: an axe head comprising a front end and a back end, wherein the front end comprises two inclined substantially flat planes ending distally with a first blade edge, wherein the front end further comprises an opening for receiving an elongated handle configured to held by at least one hand, wherein the handle comprises a bottom end and top end, wherein the top end is received within an opening on the axe head, wherein the first blade edge is substantially parallel with the elongated handle, wherein the back end of the axe head comprises a single inclined substantially flat blade ending distally with a beveled second blade edge, wherein the single inclined flat plane of the back end is substantially perpendicular with the two inclined flat planes of the front end, wherein the single inclined flat blade of the back end comprises a substantially flat top surface, a substantially flat bottom surface, and substantially flat side surfaces, and further wherein a proximal end of the single inclined substantially flat blade comprises a flexible hinge that allows the blade to pivot upwards and downwards as a result of applied force.

Another embodiment of the subject invention is an improved axe head comprising a front end and a back end, wherein the front end comprises two inclined substantially flat planes ending distally with a double-beveled first blade edge, further wherein the double-beveled first blade edge further comprises a toe on a top portion and a heel on a bottom portion, wherein the front end further comprises an opening for receiving an elongated handle configured to held by at least one hand, wherein the handle comprises a bottom end and top end, wherein the top end is received within an opening on the axe head, wherein the double-beveled first blade edge is substantially parallel with the elongated handle, wherein the back end of the axe head comprises a single inclined substantially flat blade ending distally with a beveled second blade edge, wherein the single inclined flat plane of the back end is substantially perpendicular with the two inclined flat planes of the front end, wherein the single inclined flat blade of the back end comprises a substantially flat top surface, a substantially flat bottom surface, and substantially flat side surfaces, and further wherein a proximal end of the single inclined substantially flat blade comprises a flexible hinge that allows the blade to pivot upwards and downwards as a result of applied force.

A further embodiment of the subject invention is an improved axe head comprising: a front end and a back end, wherein the front end comprises two inclined substantially flat planes ending distally with a first blade edge, further wherein the first blade edge further comprises a toe on a top portion and a heel on a bottom portion, wherein the front end further comprises an opening for receiving an elongated handle configured to held by at least one hand, wherein the handle comprises a bottom end and top end, wherein the top end is received within an opening on the axe head, wherein the first blade edge is substantially parallel with the elongated handle, wherein the back end of the axe head comprises a single inclined substantially flat blade ending distally with a beveled second blade edge, wherein the single inclined flat plane of the back end is substantially perpendicular with the two inclined flat planes of the front end, wherein the single inclined flat blade of the back end comprises a substantially flat top surface, a substantially flat bottom surface, and substantially flat side surfaces, and further wherein a proximal end of the single inclined substantially flat blade comprises a flexible hinge that allows the blade to pivot upwards and downwards as a result of applied force.

An additional embodiment of the subject invention is an improved axe head comprising: a front end and a back end, wherein the front end comprises two inclined substantially flat planes ending distally with a double-beveled first blade edge, wherein the front end further comprises an opening for receiving an elongated handle configured to held by at least one hand, wherein the handle comprises a bottom end and top end, wherein the top end is received within an opening on the axe head, wherein the double-beveled first blade edge is substantially parallel with the elongated handle, wherein the back end of the axe head comprises a single inclined substantially flat blade ending distally with a beveled second blade edge, wherein the single inclined flat plane of the back end is substantially perpendicular with the two inclined flat planes of the front end, wherein the single inclined flat blade of the back end comprises a substantially flat top surface, a substantially flat bottom surface, and substantially flat side surfaces, and further wherein a proximal end of the single inclined substantially flat blade comprises a flexible hinge that allows the blade to pivot upwards and downwards as a result of applied force.

Another embodiment of the subject invention is an improved axe head comprising: a front end and a back end, wherein the front end comprises two inclined substantially flat planes ending distally with a first blade edge, wherein the front end further comprises an opening for receiving an elongated handle configured to held by at least one hand, wherein the handle comprises a bottom end and top end, wherein the top end is received within an opening on the axe head, wherein the first blade edge is substantially parallel with the elongated handle, wherein the back end of the axe head comprises a single inclined substantially flat blade ending distally with a beveled second blade edge, wherein the single inclined flat plane of the back end is substantially perpendicular with the two inclined flat planes of the front end, wherein the single inclined flat blade of the back end comprises a substantially flat top surface, a substantially flat bottom surface, and substantially flat side surfaces, and further wherein a proximal end of the single inclined substantially flat blade comprises a flexible hinge that allows the blade to pivot upwards and downwards as a result of applied force.

A further embodiment of the subject invention is a handheld cutting tool comprising: an axe head comprising a front end and a back end, wherein the front end comprises two inclined substantially flat planes ending distally with a double-beveled first blade edge, further wherein the double-beveled first blade edge further comprises a toe on a top portion and a heel on a bottom portion, wherein the front end further comprises an opening for receiving an elongated handle configured to held by at least one hand, wherein the handle comprises a bottom end and top end, wherein the top end is received within an opening on the cutting portion of the tool, wherein the double-beveled first blade edge is substantially parallel with the elongated handle, wherein the back end of the axe head comprises a single inclined substantially flat blade ending distally with a beveled second blade edge, wherein the single inclined flat plane of the back end is substantially perpendicular with the two inclined flat planes of the front end, wherein the single inclined flat blade of the back end comprises a substantially flat top surface, a substantially flat bottom surface, and substantially flat side surfaces, and further wherein a proximal end of the single inclined substantially flat blade comprises a flexible hinge that allows the blade to pivot upwards and downwards as a result of applied force.

Another embodiment of the subject invention is a handheld cutting tool comprising: an axe head comprising a front end and a back end, wherein the front end comprises two inclined substantially flat planes ending distally with a first blade edge, further wherein the first blade edge further comprises a toe on a top portion and a heel on a bottom portion, wherein the front end further comprises an opening for receiving an elongated handle configured to held by at least one hand, wherein the handle comprises a bottom end and top end, wherein the top end is received within an opening on the cutting portion of the tool, wherein the double-beveled blade edge is substantially parallel with the elongated handle, wherein the back end of the axe head comprises a single inclined substantially flat blade ending distally with a beveled second blade edge, wherein the single inclined flat plane of the back end is substantially perpendicular with the two inclined flat planes of the front end, wherein the single inclined flat blade of the back end comprises a substantially flat top surface, a substantially flat bottom surface, and substantially flat side surfaces, and further wherein a proximal end of the single inclined substantially flat blade comprises a flexible hinge that allows the blade to pivot upwards and downwards as a result of applied force.

An additional embodiment of the subject invention is a handheld cutting tool comprising: an axe head comprising a front end and a back end, wherein the front end comprises two inclined substantially flat planes ending distally with a double-beveled first blade edge, wherein the front end further comprises an opening for receiving an elongated handle configured to held by at least one hand, wherein the handle comprises a bottom end and top end, wherein the top end is received within an opening on the cutting portion of the tool, wherein the double-beveled first blade edge is substantially parallel with the elongated handle, wherein the back end of the axe head comprises a single inclined substantially flat blade ending distally with a beveled second blade edge, wherein the single inclined flat plane of the back end is substantially perpendicular with the two inclined flat planes of the front end, wherein the single inclined flat blade of the back end comprises a substantially flat top surface, a substantially flat bottom surface, and substantially flat side surfaces, and further wherein a proximal end of the single inclined substantially flat blade comprises a flexible hinge that allows the blade to pivot upwards and downwards as a result of applied force.

A further embodiment of the subject invention is a handheld cutting tool comprising: an axe head comprising a front end and a back end, wherein the front end comprises two inclined substantially flat planes ending distally with a first blade edge, wherein the front end further comprises an opening for receiving an elongated handle configured to held by at least one hand, wherein the handle comprises a bottom end and top end, wherein the top end is received within an opening on the cutting portion of the tool, wherein the first blade edge is substantially parallel with the elongated handle, wherein the back end of the axe head comprises a single inclined substantially flat blade ending distally with a beveled second blade edge, wherein the single inclined flat plane of the back end is substantially perpendicular with the two inclined flat planes of the front end, wherein the single inclined flat blade of the back end comprises a substantially flat top surface, a substantially flat bottom surface, and substantially flat side surfaces, and further wherein a proximal end of the single inclined substantially flat blade comprises a flexible hinge that allows the blade to pivot upwards and downwards as a result of applied force.

In other embodiments of the subject invention, the handles may comprise a material selected from the group consisting of wood, plastics, and fiberglass.

In further embodiments of the subject invention, the axe heads may comprise a material selected from the group consisting of steel and titanium alloy.

In additional embodiments of the subject invention, the axe heads may comprise a cast molded unitary piece.

In other embodiments of the subject invention, the cutting portion of the tool may comprise a cast molded unitary piece.

In further embodiments of the subject invention, the cutting portion of the tool may comprise a material selected from the group consisting of steel and titanium alloy.

There have thus been broadly outlined important features of the invention in order that the detailed description thereof that follows may be better understood, and in order that the present contribution to the art may be better appreciated. There are additional features of the invention that will be described hereinafter and which will form the subject matter of the claims appended hereto. These together with other embodiments of the invention, and with various features of novelty which characterize the invention, are pointed out with particularity in the claims annexed to and formed as part of this disclosure.

For a conceptual understanding of the invention and its operational advantages, refer to the accompanying drawings and descriptive matter in which there are preferred embodiments of the invention illustrated. Other features and advantages of the present invention will become apparent from the following description of the preferred embodiment(s), taken in conjunction with the accompanying drawings, which by way of example; illustrate the principles of the invention.

### BRIEF DESCRIPTION OF THE DRAWINGS

Advantages of the present invention will be apparent from the following detailed description of embodiments thereof, which description should be considered in conjunction with the accompanying drawings, in which:

FIG. 1 illustrates a top front perspective view of one embodiment of the modified axe.

FIG. 2 illustrates a bottom front perspective view of one embodiment of the modified axe.

FIG. 3 illustrates a top rear view of one embodiment of the modified axe.

FIG. 4 illustrates a bottom rear perspective view of one embodiment of the modified axe.

FIG. 5 illustrates a side view of one embodiment of the modified axe.

FIG. 6 illustrates a top view of one embodiment of the modified axe.

FIG. 7 illustrates a bottom view of one embodiment of the modified axe.

FIG. 8 illustrates a rear view of one embodiment of the modified axe.

FIG. 9 illustrates a front view of one embodiment of the modified axe.

### DETAILED DESCRIPTION OF THE EMBODIMENTS

While several variations of the present invention have been illustrated by way of example in particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

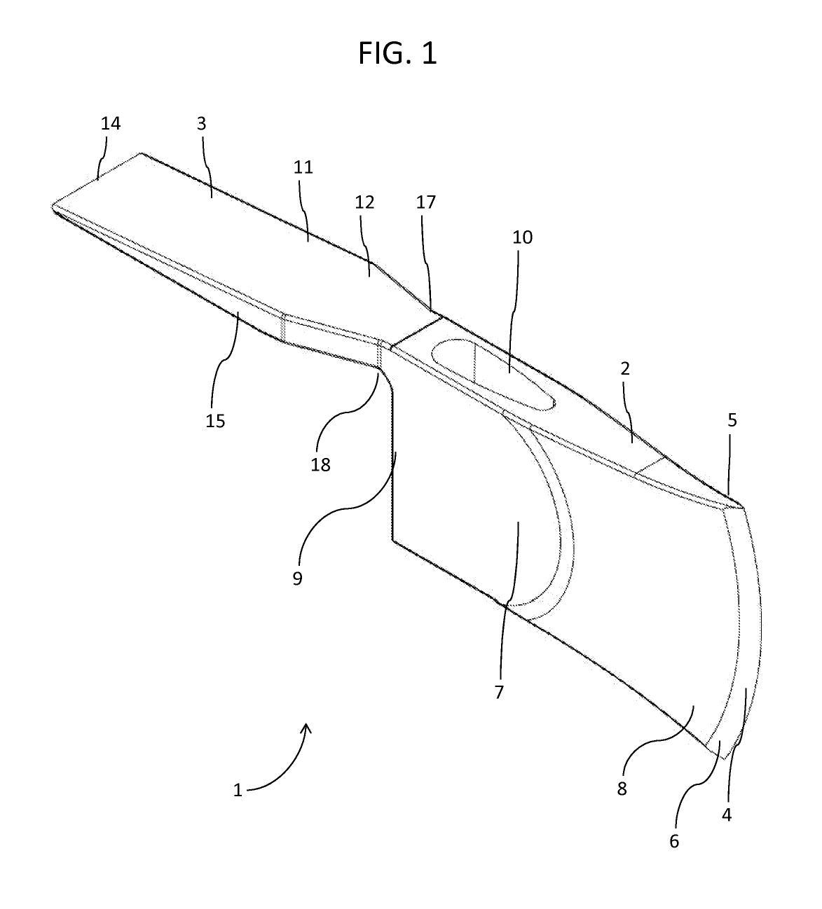

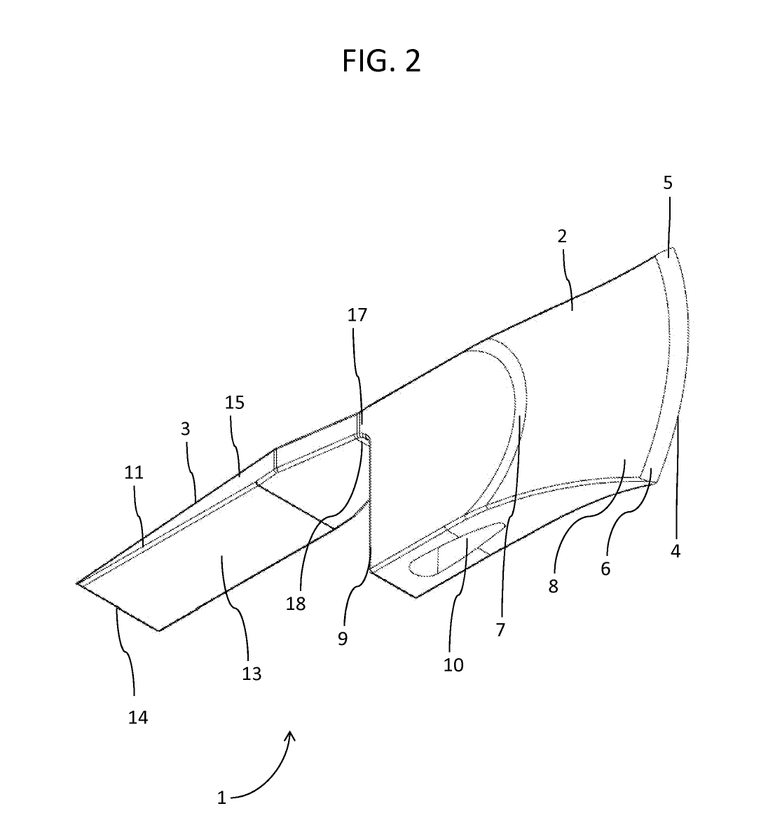

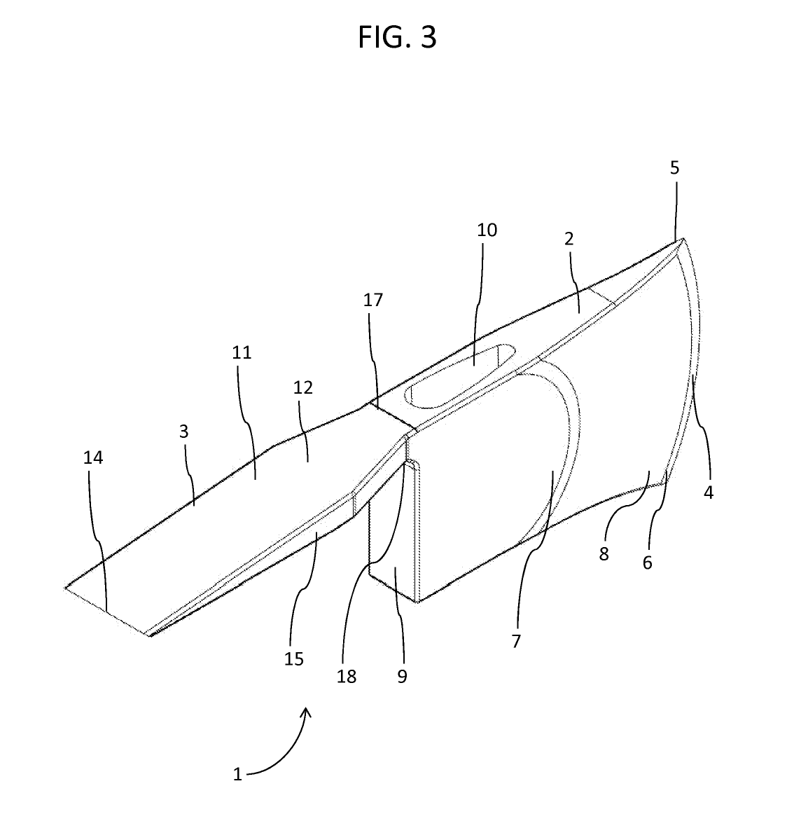

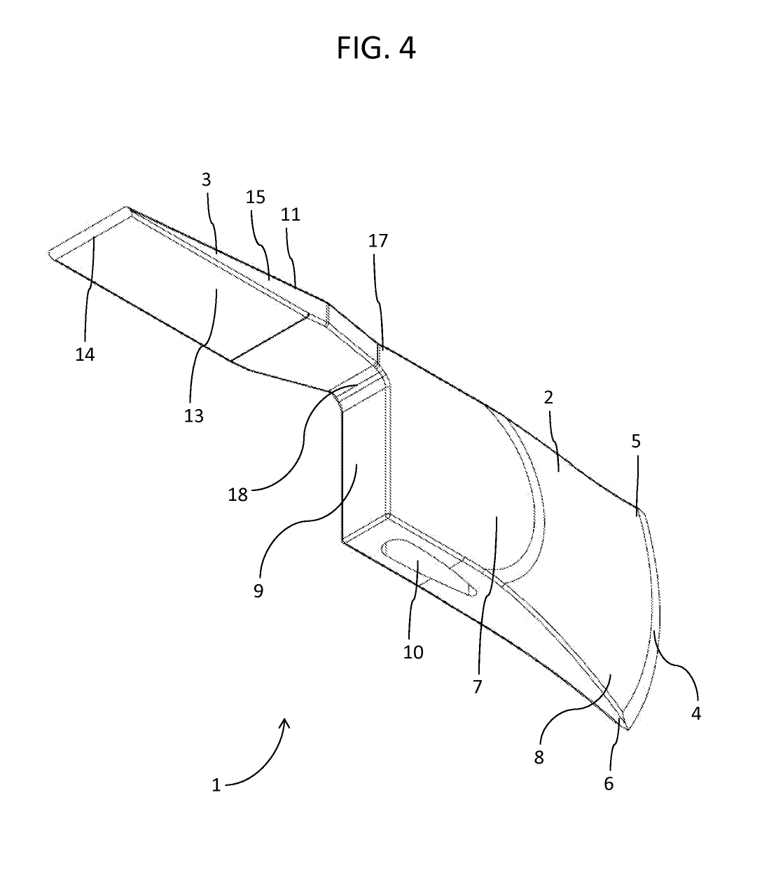

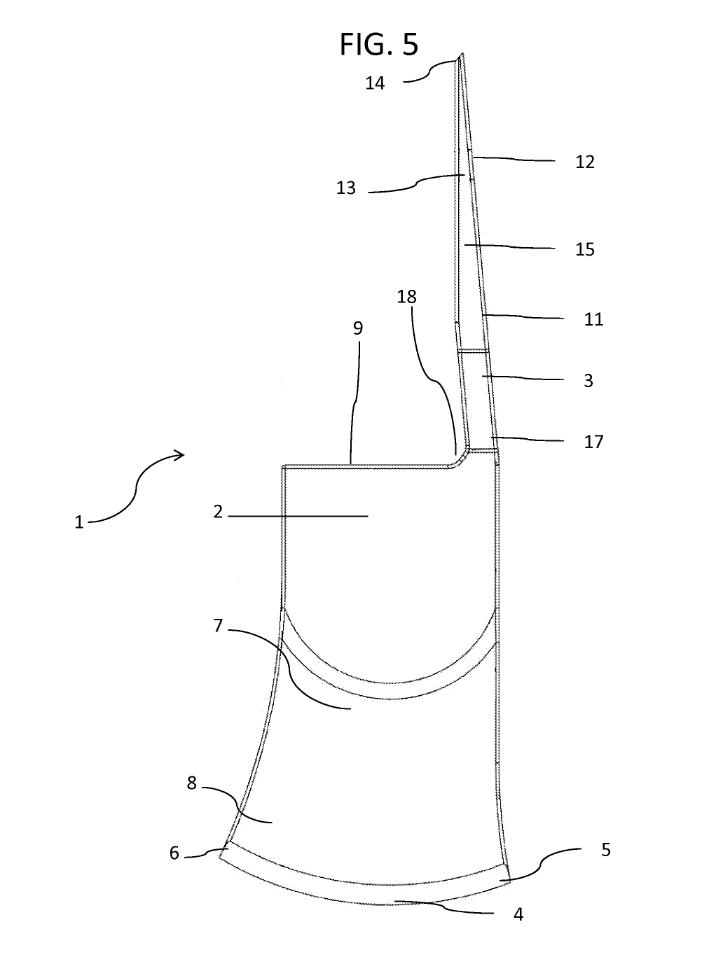

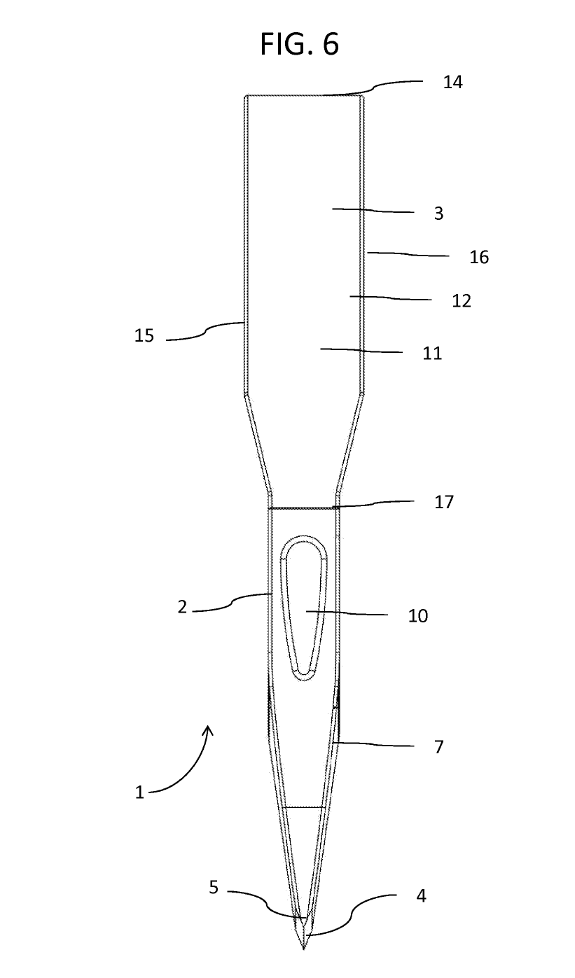

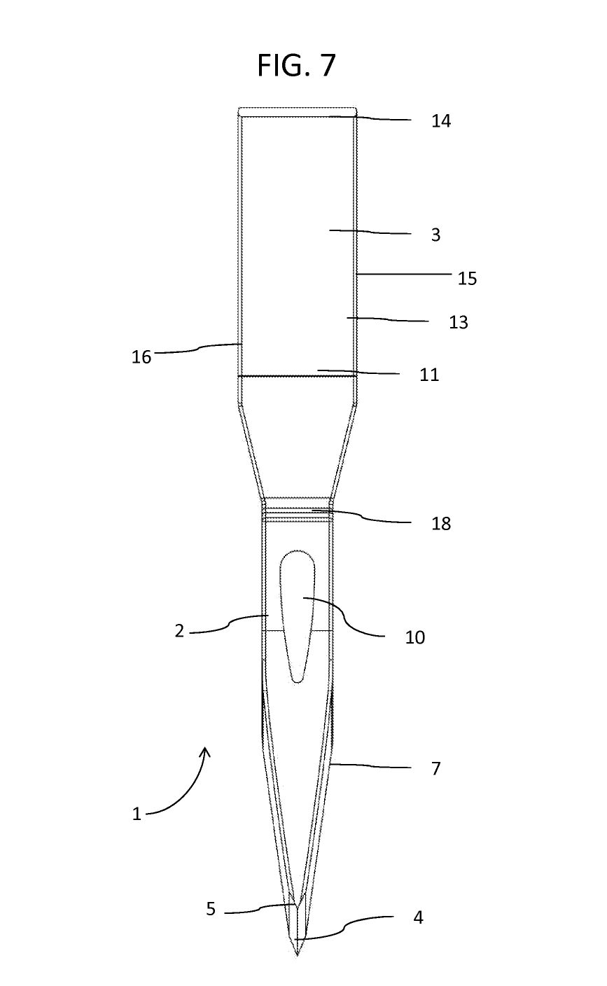

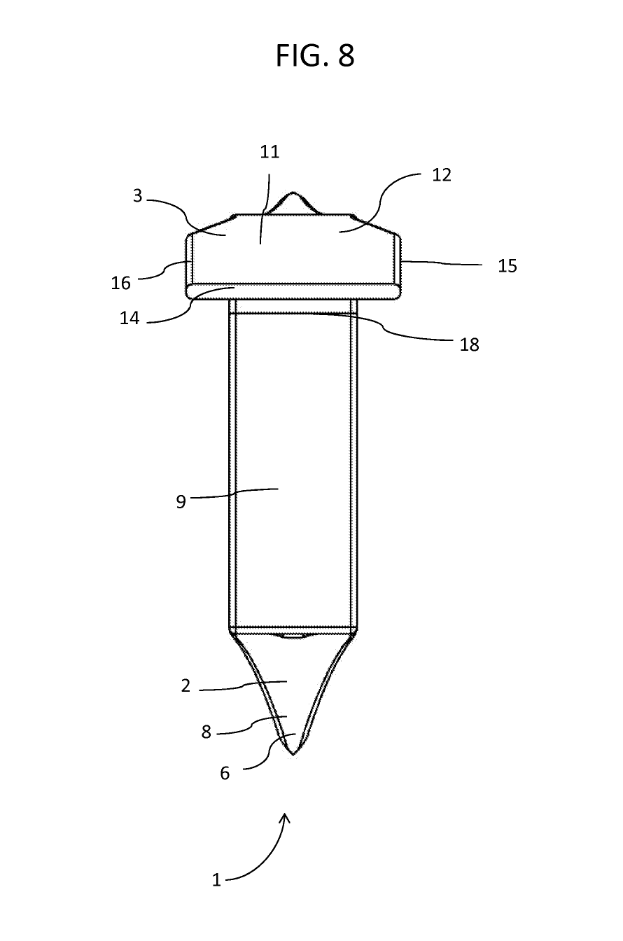

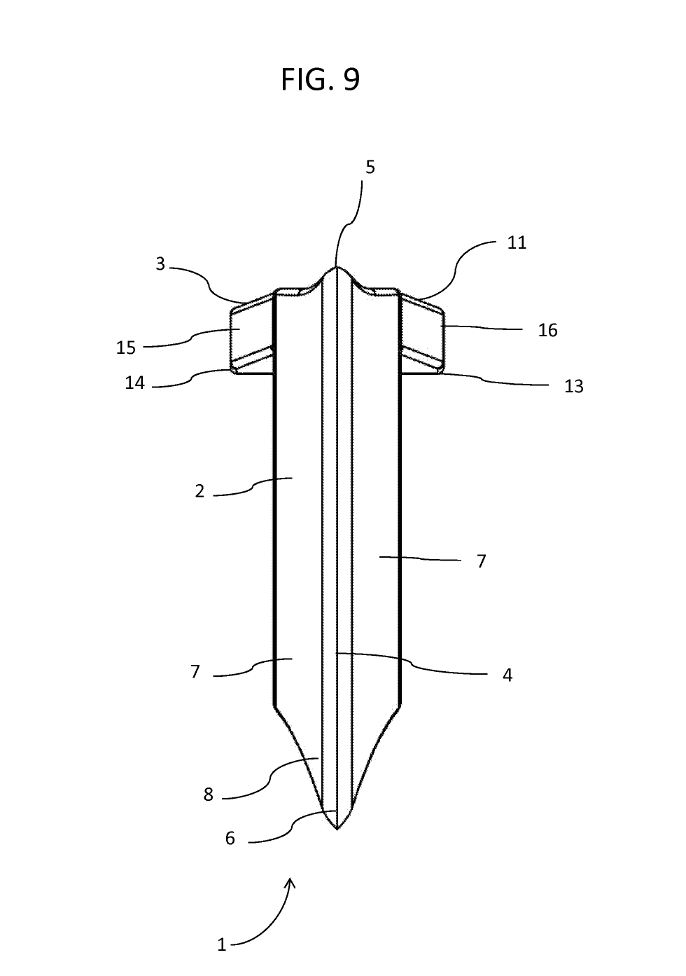

As illustrated in FIG. 1-9, the subject invention is a modified axe head 1 that comprises a front-end double-beveled blade 2 and a back end beveled adze 3. The blade 2 of the axe head 1 is a dual-inclined plane comprising a blade edge 4, a toe 5, a heel 6, cheeks 7, a beard 8, a butt 9, and an eye 10 where an axe handle (not shown) may be mounted. The axe head 1 is composed of a single casted piece of a strong and durable metal such as steel or a titanium alloy. The axe handle (not shown) may comprise a standard elongated handle with a top end affixed through the hollow eye 10 and a bottom end. The axe handle may be composed of wood, plastics, or fiberglass. The handle of the axe acts as a lever allowing a user to increase the amount of applied force at the blade edge 4.

The back end adze 3 comprises a straight, substantially flat blade 11 with a substantially flat top surface 12, a substantially flat bottom surface 13, and a beveled blade edge 14. The top surface 12 of the adze 3 may be substantially perpendicular with the butt 9 or it may extend at an angle with regard to the butt 9. The blade edge 14 may be substantially perpendicular with the blade edge 4 of the blade 2. The right surface 15 and the left surface 16 of the adze 3 are substantially flat and substantially parallel with blade edge 4 of blade 2.

The proximal end 17 of the adze 3, the end proximate to the eye 10, comprises a flexible hinge point 18 that allows the blade 11 to pivot upwards and downwards as a result of applied force.

In use, the axe blade 2 may slowly draw the axe head 1 rearward behind the user's head, and then rapidly swing the axe head 1 forward at an object in front of the user. This rotation of the axe head 1 produces a significant amount of torque that is released at the blade edge 4 when the blade edge 4 contacts a surface. This applied force may be used to break down doors, windows, walls, ceilings, floors, trees, and many other fixtures, such as furniture. This blunt force allows firefighters to forcible enter closed portions of a burning building by breaking down locked or blocked doors, breaking through walls or fallen debris, and breaking through floors or ceilings.

The bevel edge of the adze can be quickly inserted by firefighters in between doors, wall holes, floorboards, or roofing tiles for more gently opening or removing these obstacles in old or unstable buildings during search and rescue operations. A firefighter may slowly draw the axe head 1 rearward behind the user's head with the back end adze 3 facing forwards, and then slowly swing the adze 3 toward the obstacle in front of the user. The firefighter may reduce the rotation to produce a smaller amount of torque on the blade edge 14. The force causes the blade edge 14 to penetrate the obstacle. Furthermore, the flexible hinge point 18 on the adze blade 11 may allow a firefighter to simply insert the blade edge 14 into small spaces in doors, walls holes, floorboards, and roofing tiles and pull the axe handle to more gently remove the obstacles. This gentle removal or enlarging may be beneficial when the burning structure is unstable or old and a larger applied force may create a possible hazard to the firefighter or the victims by bring portions of the building structure down on top of them.

The bevel edge of the adze can also be used to quickly make wall holes, ceiling holes, and floor holes in a burning building to search for hidden pockets of fire, or extensions, to prevent the fire from a spreading. A process called overhaul. A firefighter may slowly draw the axe head 1 rearward behind the user's head with the back end adze 3 facing forwards, and then rapidly swing the adze 3 toward the obstacle in front of the user. This rotation of the adze 3 produces a significant amount of torque that is released at the blade edge 14 when the blade edge 14 contacts the obstacle. The firefighter may reduce the rotation to produce a smaller amount of torque on the blade edge 14. The force causes the blade edge 14 to penetrate the obstacle. A small amount of force may only be necessary to determine of the wall, ceiling, or floor contains an extension. Furthermore, creating a small hole with the adze 3 blade edge 14 will be beneficial since a larger hole over a hidden extension may results in a large influx of oxygen to the extension created a possible hazard to the firefighter directly or by spreading the fire in the structure.

The bevel edge of the adze can be inserted in between doors, wall holes, floor boards, or roofing tiles for harvesting doors, windows, floor boards, or roofing tiles for construction projects or for removing these obstacles for remodeling. A user may slowly draw the axe head 1 rearward behind the user's head with the back end adze 3 facing forwards, and then slowly swing the adze 3 toward the obstacle in front of the user. The user may reduce the rotation to produce a smaller amount of torque on the blade edge 14. The force causes the blade edge 14 to penetrate the obstacle. Furthermore, the flexible hinge point 18 on the adze blade 11 may allow a user to simply insert the blade edge 14 into small spaces in doors, walls holes, floorboards, and roofing tiles and pull the axe handle to more gently harvest the materials for reuse.

The back end adze 3 may be used to dig through and around roots or other hard soils, for gardening or for creating firebreaks in forest or crop fires. A user may slowly draw the axe head 1 rearward behind the user's head with the back end adze 3 facing forwards, and then rapidly swing the adze 3 toward the soil in front of the user. This rotation of the adze 3 produces a significant amount of torque that is released at the blade edge 14 when the blade edge 14 contacts the soil. The force causes the blade edge 14 to penetrate the soil, which is then carried on the bottom surface 13 as the adze 3 continues the rotational movement. The substantially flat top surface 12, right surface 15, and left surface 16 of the adze 3 allows it to move freely over the soil underneath the penetrating blade edge 14. The narrowness of the flat blade 11 allows the adze 3 to move soil between the narrow spaces of roots. The back end adze 3 may also be used for smoothing or carving wood by swinging the adze downwards onto a piece of wood. A user may slowly draw the axe head 1 rearward behind the user's head with the back end adze 3 facing forwards, and then rapidly swing the adze 3 toward the wood in front of the user. This rotation of the adze 3 produces a significant amount of torque that is released at the blade edge 14 when the blade edge 14 contacts the wood. The force causes the blade edge 14 to penetrate the wood, which is then carried on the bottom surface 13 as the adze 3 continues the rotational movement. The substantially flat top surface 12, right surface 15, and left surface 16 of the adze 3 allows it to move freely over the wood underneath the penetrating blade edge 14. The adze 3 will chip away wood pieces leaving a somewhat smoother surface on the wood.

What is claimed is:

1. An improved axe comprising:
an axe head comprising a front end and a back end, wherein the front end comprises two inclined substantially flat planes ending distally with a double-beveled first blade edge, further wherein the double-beveled first blade edge further comprises a toe on a top portion and a heel on a bottom portion,
wherein the front end further comprises an opening for receiving an elongated handle configured to held by at least one hand, wherein the handle comprises a bottom end and top end, wherein the top end is received within an opening on the axe head,
wherein the double-beveled first blade edge is substantially parallel with the elongated handle,
wherein the back end of the axe head comprises a single inclined substantially flat blade ending distally with a beveled second blade edge, wherein the single inclined flat plane of the back end is substantially perpendicular with the two inclined flat planes of the front end, wherein the single inclined flat blade of the back end comprises a substantially flat top surface, a substantially flat bottom surface, and substantially flat side surfaces,
and further wherein a proximal end of the single inclined substantially flat blade comprises a flexible hinge that allows the blade to pivot upwards and downwards as a result of applied force.

2. The axe of claim 1, wherein the handles may comprise a material selected from the group consisting of wood, plastics, and fiberglass.

3. The axe of claim 1, wherein the axe heads may comprise a material selected from the group consisting of steel and titanium alloy.

4. The axe of claim 1, wherein the axe heads may comprise a cast molded unitary piece.

5. An improved axe comprising:
an axe head comprising a front end and a back end, wherein the front end comprises two inclined substantially flat planes ending distally with a first blade edge, further wherein the first blade edge further comprises a toe on a top portion and a heel on a bottom portion,
wherein the front end further comprises an opening for receiving an elongated handle configured to held by at least one hand, wherein the handle comprises a bottom end and top end, wherein the top end is received within an opening on the axe head,
wherein the first blade edge is substantially parallel with the elongated handle,
wherein the back end of the axe head comprises a single inclined substantially flat blade ending distally with a beveled second blade edge, wherein the single inclined flat plane of the back end is substantially perpendicular with the two inclined flat planes of the front end, wherein the single inclined flat blade of the back end comprises a substantially flat top surface, a substantially flat bottom surface, and substantially flat side surfaces,
and further wherein a proximal end of the single inclined substantially flat blade comprises a flexible hinge that allows the blade to pivot upwards and downwards as a result of applied force.

6. The axe of claim 5, wherein the handles may comprise a material selected from the group consisting of wood, plastics, and fiberglass.

7. The axe of claim 5, wherein the axe heads may comprise a material selected from the group consisting of steel and titanium alloy.

8. The axe of claim 5, wherein the axe heads may comprise a cast molded unitary piece.

9. An improved axe comprising:
an axe head comprising a front end and a back end, wherein the front end comprises two inclined substantially flat planes ending distally with a double-beveled first blade edge,
wherein the front end further comprises an opening for receiving an elongated handle configured to held by at least one hand, wherein the handle comprises a bottom end and top end, wherein the top end is received within an opening on the axe head,
wherein the double-beveled first blade edge is substantially parallel with the elongated handle,
wherein the back end of the axe head comprises a single inclined substantially flat blade ending distally with a beveled second blade edge, wherein the single inclined flat plane of the back end is substantially perpendicular with the two inclined flat planes of the front end, wherein the single inclined flat blade of the back end comprises a substantially flat top surface, a substantially flat bottom surface, and substantially flat side surfaces,
and further wherein a proximal end of the single inclined substantially flat blade comprises a flexible hinge that allows the blade to pivot upwards and downwards as a result of applied force.

10. The axe of claim 9, wherein the handles may comprise a material selected from the group consisting of wood, plastics, and fiberglass.

11. The axe of claim 9, wherein the axe heads may comprise a material selected from the group consisting of steel and titanium alloy.

12. The axe of claim 9, wherein the axe heads may comprise a cast molded unitary piece.
